(19) United States
(12) Patent Application Publication
(10) Pub. No.: US 2012/0014142 A1
(43) Pub. Date: Jan. 19, 2012

(54) POWER CONVERSION APPARATUS FOR CORRECTING POWER FACTOR

(75) Inventors: KUN-NAN TSAI, Taipei City (TW); Fu-Tien Lee, Lujhou City (TW)

(73) Assignee: WELLAND INDUSTRIAL CO., LTD.

(21) Appl. No.: 12/838,791

(22) Filed: Jul. 19, 2010

(51) Int. Cl. H02M 3/335

(52) U.S. Cl. 363/21.17

(57) ABSTRACT

A power conversion apparatus for correcting power factor, which converts an input voltage to an output voltage, comprises: an inductive component, a unidirectional conducting component, a switch, an energy storage component, a capacitive component, and an output circuit. The unidirectional conducting component connects to the inductive component and the switch in series. The energy storage component connects to the switch and the capacitive component in series. The capacitive component has a bias voltage. The output circuit couples to the energy storage component for outputting the output voltage. Wherein, the switch in a conduction state is capable of charging the inductive component by applying the input voltage and charging the energy storage component by applying the bias voltage, and the switch in a cutoff state is capable of discharging the capacitive component and the energy storage component to the output circuit and discharging the inductive component to the capacitive component.

### BACKGROUND OF THE INVENTION

1. Field of the Invention

The present invention relates to a power conversion apparatus, and more particularly, to a power conversion apparatus with a high power factor.

2. Description of Related Art

A primary objective of a power factor correction (PFC) is to make an electronic device circuitry that is power factor corrected appear purely resistive. In other words, the output voltage and the input current of the electronic device are in phase and the load of the electronic device is closed to a capacitive load, such that the load with a high power factor is achieved.

Refer FIG. 1, in which a schematic diagram of a DC power supply with a power factor corrector according to the prior art is demonstrated. A DC power supply 1 comprises an EMI (electromagnetic interference) filter circuit 11, a rectifying circuit 13, a power factor corrector 10, and a voltage converter 12. The rectifying circuit 13 receives an AC input power (AC) by ways of the EMI filter circuit, converts the AC input power (AC) to a DC voltage (DC), and transfers the DC voltage (DC) to the power factor corrector 10.

The power factor corrector 10 includes a power factor correction stage 101 and a power factor control stage 102. For the power factor correction stage 101, there are several common topologies presently, a boost type, a buck type, and a flyback topology, etc. With regard to the aforementioned topologies, because the boost type is used to achieve an effect with the high power factor and a low harmonic content by applying a single stage circuitry, the boost type is most common to be applied in the power factor corrector 10. For the power factor control stage 102, a power factor correction controller 1020 is commonly utilized to drive a power switch Q3 which is determined by the output voltage, the input current, the input voltage, other signals, etc., of the power factor correction stage 101. Thereby, the high frequency switching power switch Q3 is used to make the input current and the AC input power (AC) to be in phase, so that the objective of increasing the power factor is achieved.

Additionally, the voltage converter 12 further includes a power factor correction stage 121 and a power factor control stage 122, wherein, the power factor correction stage 121 has the following common topologies: a boost type, a buck type, and a flyback topology, etc. For the power factor control stage 122, a pulse width modulation controller 1220 is usually applied to get the output voltage Vo, the output current Io, other signals, etc., of the power factor correction stage 121 by means of a feedback circuit 1222 to drive a power switch Q1. As such, the high frequency switching power switch Q1 is used to achieve the objective for maintaining the output voltage Vo and the output current Io.

The DC power supply 1 is advantageous to perform conversion in two stages for getting a high power factor and a stable output voltage and current. Yet, this kind of DC power supply 1 requires two groups of power factor correction stage and two groups of power factor control stage, such that the circuit topology thereof is very complicated and the manufacturing cost is relatively higher.

### SUMMARY OF THE INVENTION

The above deficiencies and problems associated with the conventional DC power supply are eliminated by the disclosed power conversion apparatus for correcting power factor according to the present invention. The power conversion apparatus utilizes a single stage control method and makes improvements on the circuitry configuration, thereby increasing the power factor and maintaining the stable output current or voltage.

An embodiment of the power conversion apparatus for correcting the power factor according to the present invention converts an input voltage to an output voltage. The disclosed power conversion apparatus comprises: an inductive component, a unidirectional conducting component, a switch, an energy storage component, a capacitive component, and an output circuit. The inductive component receives the input voltage. The unidirectional conducting component connects to the inductive component and the switch in series. The energy storage component connects to the switch and the capacitive component in series. The capacitive component has a bias voltage. The output circuit couples to the energy storage component for outputting the output voltage. Wherein, the switch in a conduction state is capable of charging the inductive component by applying the input voltage and charging the energy storage component by applying the bias voltage, and the switch in a cutoff state is capable of discharging the capacitive component and the energy storage component to the output circuit and discharging the inductive component to the capacitive component.

In the embodiment according to the present invention, the power conversion apparatus for correcting the power factor simplifies the circuitry topology of the conventional power supply and utilizes the signal stage control method so as to provide the power factor higher than 0.98 and maintain the output stability. Meanwhile, the power conversion apparatus for correcting the power factor uses a single inductive component so as to reduce electromagnetic interference of the power source. Also, it overcomes deficiencies and problems associated with the conventional DC power supply which can't take into account of the power factor correction, electromagnetic interference, and the output stability concurrently.

In order to further understand the techniques, means and effects the present invention, the following detailed description and included drawings are hereby referred, such that, through which, the purposes, features and aspects of the present invention can be thoroughly and concretely appreciated; however, the included drawings are provided solely for reference and illustration, without any intention to be used for limiting the present invention.

### BRIEF DESCRIPTION OF THE DRAWINGS

FIG. 1 illustrates a schematic diagram of a DC power supply with a power factor corrector according to the prior art;

FIG. 2 illustrates a schematic diagram of a first embodiment of a power conversion apparatus for correcting power factor according to the present invention;

FIG. 3A-3F illustrate waveform diagrams showing operations of the first embodiment in accordance with certain aspects of the present invention;

FIG. 4 illustrates a waveform diagram of the first embodiment in accordance with power factor correction operated in a constant frequency mode according to the present invention;

FIG. 5 illustrates a waveform diagram of the first embodiment in accordance with power factor correction operated in a variable frequency mode according to the present invention;

FIG. 6 illustrates a circuit diagram showing the first embodiment of a first application according to the present invention;

FIG. 7 illustrates a circuit diagram showing the first embodiment of a second application according to the present invention;

FIG. 8 illustrates a circuit diagram showing the first embodiment of a third application according to the present invention;

FIG. 9 illustrates a schematic diagram of a second embodiment of the power conversion apparatus for correcting power factor according to the present invention;

FIG. 10 illustrates a waveform diagram showing operations of the second embodiment in accordance with certain aspects of the present invention; and

FIG. 11 illustrates a circuit diagram showing the second embodiment of an application according to the present invention.

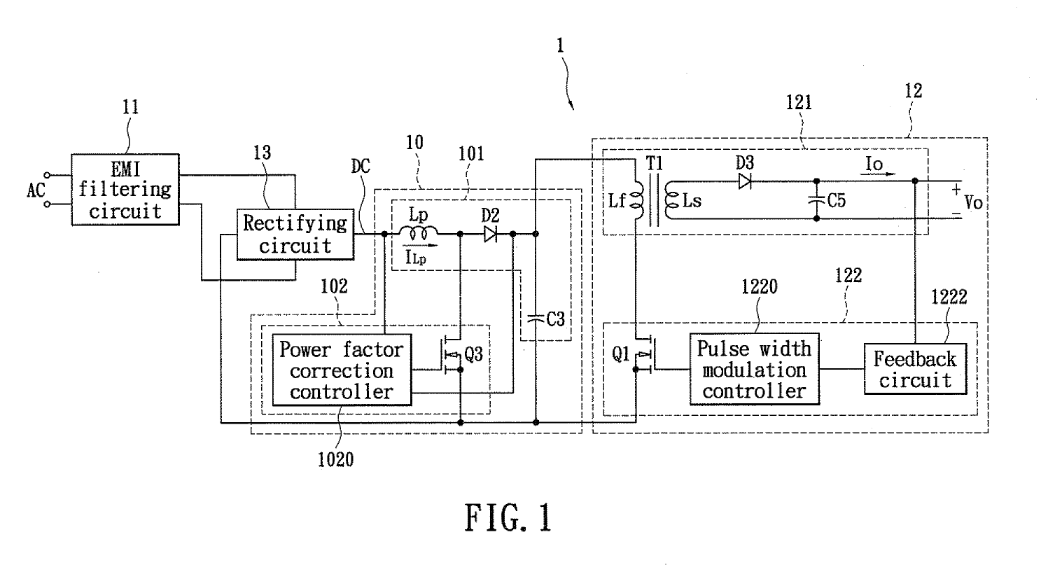

### DETAILED DESCRIPTION OF THE PREFERRED EMBODIMENTS

A power conversion apparatus for correcting a power factor according to the present invention is provided. The apparatus utilizes a single stage control method for performing the voltage conversion and supplying electrical power. In the process of supplying electrical power, it takes into consideration characteristics, such as, the power factor correction and the output stability.

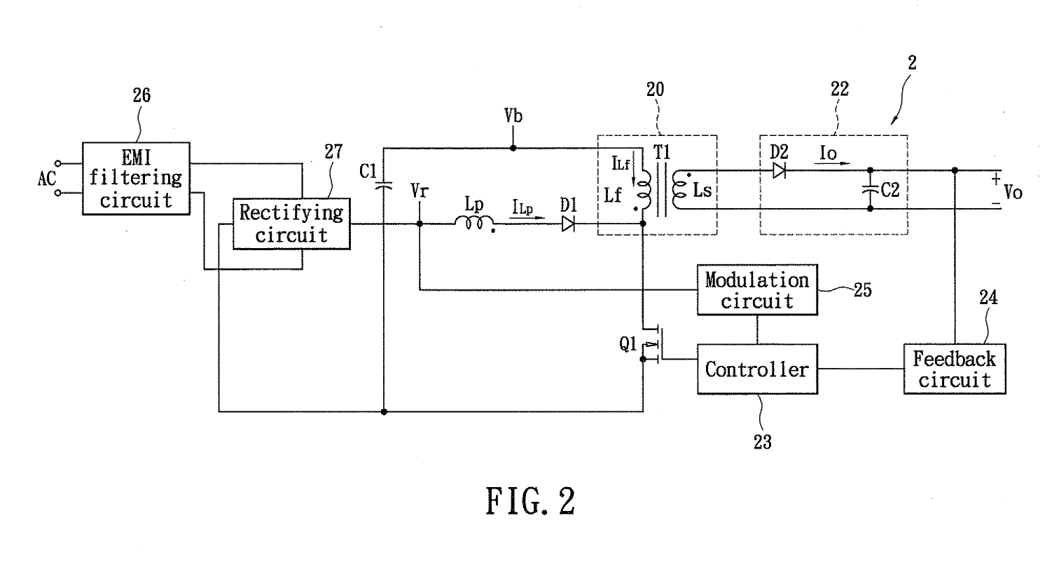

Please refer to FIG. 2, in which a schematic diagram of a first embodiment of a power conversion apparatus for correcting power factor according to the present invention is demonstrated. A power conversion apparatus for correcting power factor 2 comprises an inductive component Lp, a unidirectional conducting component D1, a switch Q1, an energy storage component 20, a capacitive component C1, and an output circuit 22. Herein, the inductive component Lp receives an input voltage Vr. The unidirectional conducting component D1 connects to the inductive component Lp and the switch Q1 in series. The energy storage component 20 connects in series to the switch Q1 and the capacitive component C1, wherein the capacitive component C1 has a bias voltage Vb. The output circuit 22 couples to the energy storage component 20 for outputting an output voltage Vo.

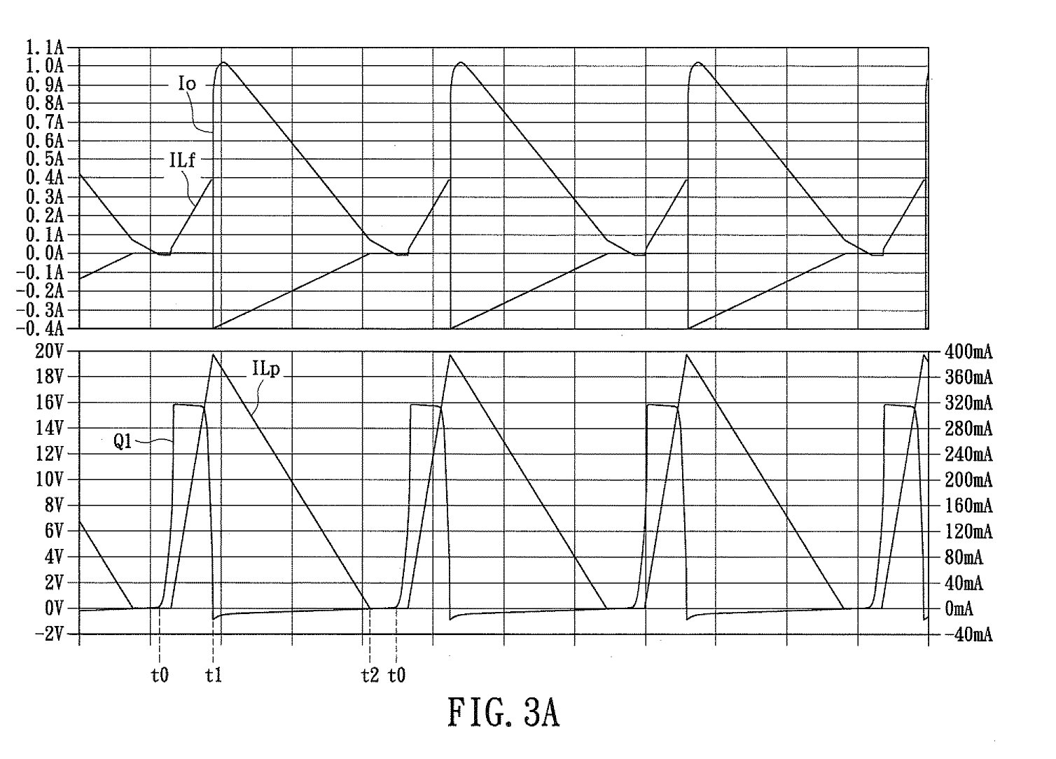

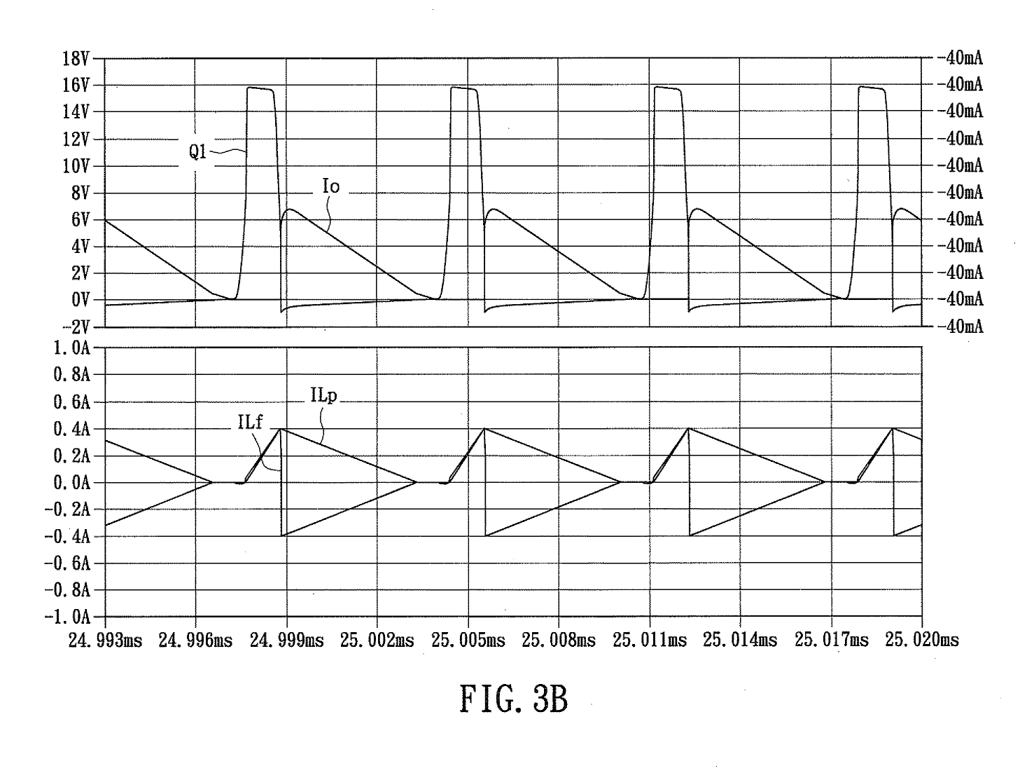

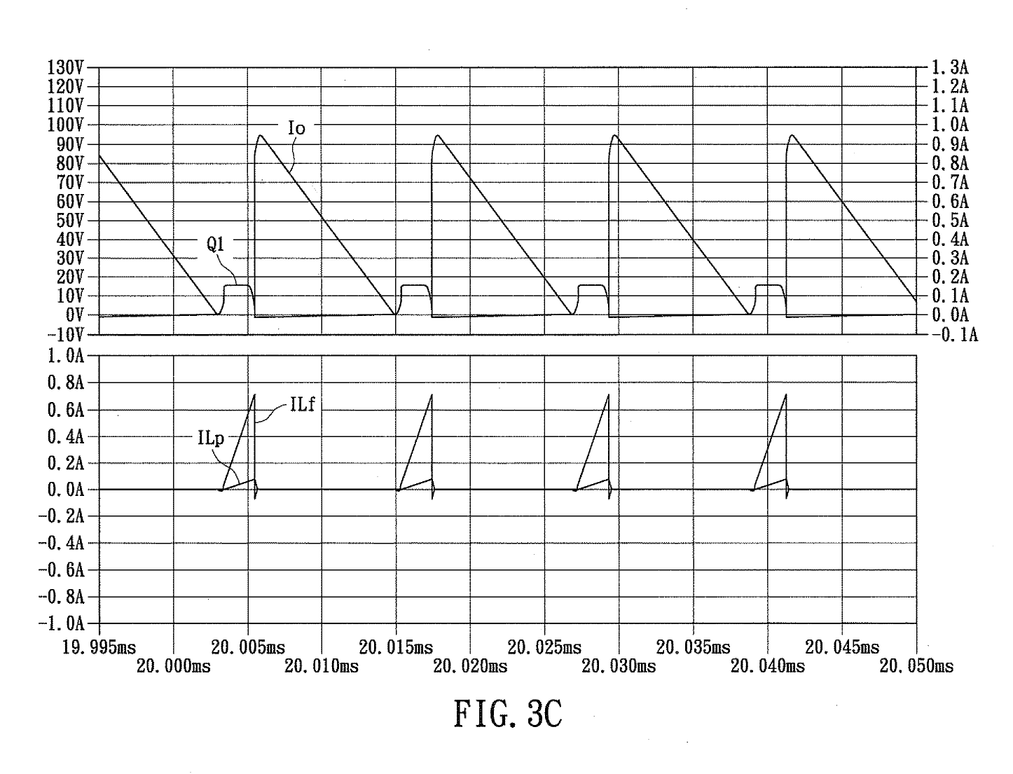

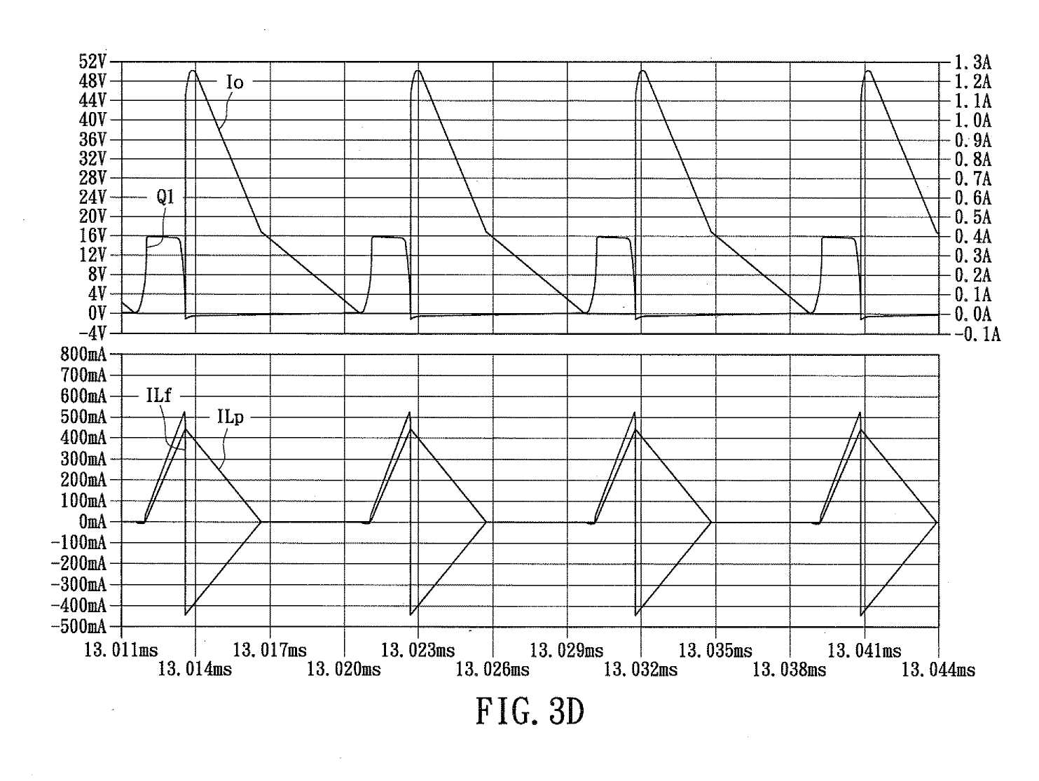

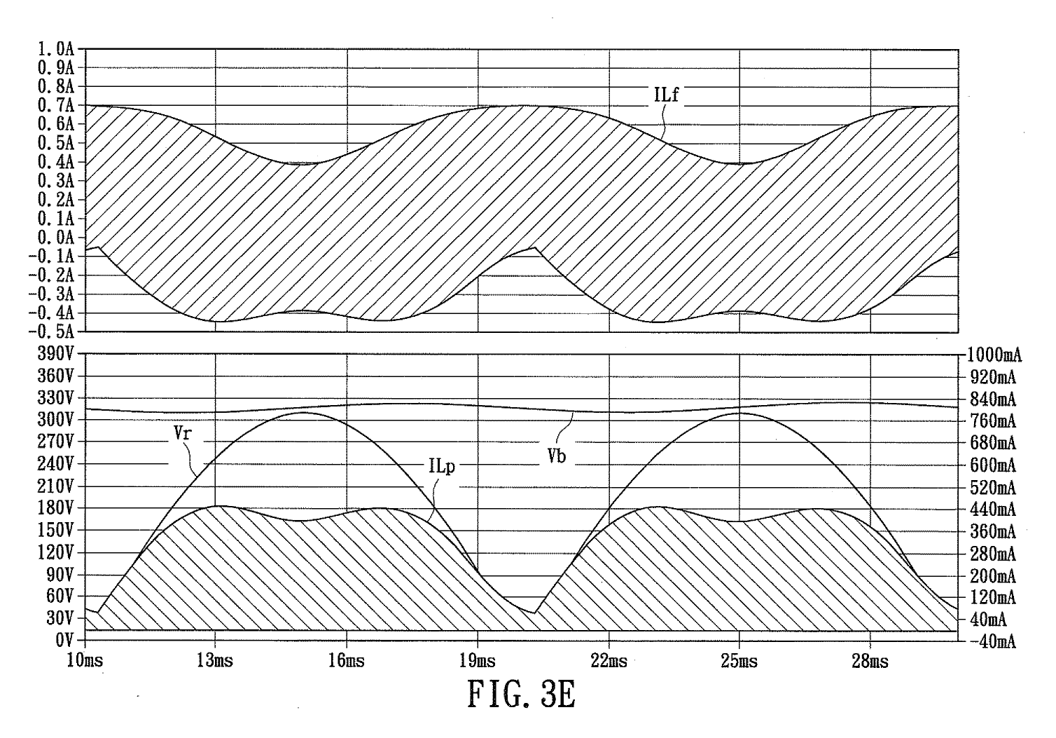

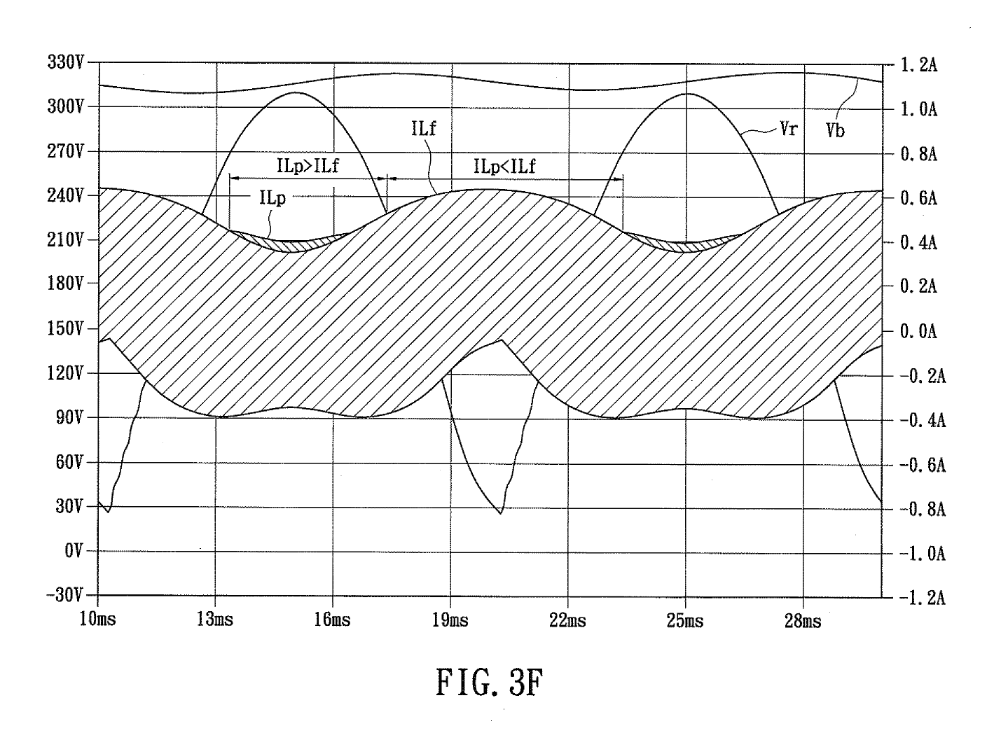

Please refer FIG. 2 in conjunction with FIG. 3A. In a time line period to-t1, the switch Q1 is controlled to be conducted. When the switch Q1 is in a conduction state, the switch Q1, the inductive component Lp, and the unidirectional conducting component D1 forms a first closed circuit loop. As such, the input voltage Vr is applied to charge the inductive component Lp, and a first current ILp passes thru the switch Q1 in the conduction state, the unidirectional conducting component D1, and thereby storing power to the inductive component Lp. Meanwhile, when the switch Q1 is in the conduction state, the switch Q1, the capacitive component C1, and the energy storage component 20 form a second closed loop. The bias voltage Vb of the capacitive component C1 is used to charge the energy storage component 20 by ways of the switch Q1 in the conduction state, and a second current Ilf passes thru the second closed loop, thereby storing power to the energy storage component 20. In the aforementioned descriptions, the energy storage component 20 may be a transformer T1.

Refer to FIG. 2 in conjunction with FIG. 3B to FIG. 3F. In a time line period t1-t2, the switch Q1 is controlled to be cut off. At the time, the power stored in the energy storage component 20 brought by the first current ILp and the second current ILf will be transferred to a secondary inductor Ls. The secondary inductor Ls generates an output current Io so as to discharge to the output circuit 22. When the switch Q1 is in a cutoff state, the first current ILp does not only pass thru the energy storage component 20 to discharge to the output circuit 22 but also pass dim a primary inductor Lf of the energy storage component 20 to charge the capacitive component C1. The magnitude of the first current ILp decreases or increases with respect to the voltage level of the input voltage Vr. As the magnitude of the first current ILp is smaller than the magnitude of the second current ILf, the level of the bias voltage Vb associated with the capacity of the capacitive component C1 may be maintained by means of discharging to the primary inductor Lf. When the magnitude of the first current ILp is larger than the magnitude of the second current ILf, the capacitive component C1 is in a charging process, for making the bias voltage Vb of the capacitive component C1 to reach a certain level.

Please refer gain FIG. 2. On the first embodiment, the unidirectional conducting component D1 may be a diode or a metal Oxide semiconductor (MOS), etc. And the inductive component Lp may be an inductor or a transformer, etc. The capacitive component C1 may be a capacitor. The output circuit 22 includes a diode D2 which connects to an output capacitor C2. As the switch Q1 is cut off, the output current Io passes thru the diode D2 for charging the output capacitor C2. The voltage level of the output capacitor C2 is the output voltage Vo.

Refer again FIG. 2. The power conversion apparatus for correcting power factor further includes a controller 23 and a feedback circuit 24. Herein, the controller 23 connects to the switch Q1 for performing switching control with respect to an operating frequency. Meanwhile, the feedback circuit 24 couples to the output circuit 22 and the controller 23. The feedback circuit 24 receives the output voltage Vo and the output current Io signals from the output circuit 22 and transmits these signals back to the controller 23 for reference. Therefore, the controller 23 may perform the switching operations of the switch Q1 with respect to the output voltage Vo, the output current Io and the operating frequency, so that the power factor correction and the output stability may be taken into consideration concurrently in the supplying power process of the power conversion apparatus 2 in accordance with certain aspects of the present invention.

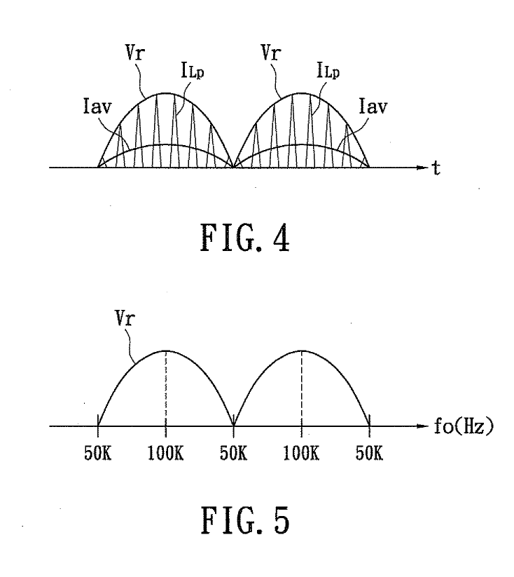

Please refer to FIG. 4 in conjunction with FIG. 2. The power conversion apparatus for correcting power factor 2 further includes an EMI filter circuit 26 and a rectifying circuit 27. The rectifying circuit 27 couples to the EMI filter circuit 26 and the inductive component Lp, wherein the rectifying circuit 27 receives an AC voltage (AC) from the EMI filter circuit 26 and rectifies the AC voltage (AC) so as to output the input voltage Vr to the inductive component Lp. As shown in FIG. 4, the output voltage Vr is a DC voltage. In the half cycle period of the input voltage Vr, the controller 23 utilizes a constant frequency method to control the switch Q1 to be switched at a high frequency, so that the phase of the average value Iav of the first current ILp matches to the phase of the input voltage Vr, thereby achieving the objective of correcting the power factor.

Please refer to FIG. 5 in conjunction with FIG. 2. The power conversion apparatus for correcting power factor 2 further includes a modulation circuit 25. The modulation circuit 25 couples to the controller 23 and the rectifying circuit 27. The modulation circuit 25 receives the output voltage Vr from the output of the rectifying circuit 27 and modulates the operating frequency fo of the controller 23 with respect to the level of the input voltage Vr. In a half cycle period of the input voltage Vr as shown in FIG. 5, the modulation circuit 25 may modulate the operating frequency fo in accordance with the level of the input voltage Vr, wherein the larger level of the input voltage Vr becomes, the larger the operating frequency fo becomes, and conversely, the smaller level of the input voltage Vr is, the smaller operating frequency fo is.

As a result, the controller 23 utilizes a variable frequency method to control the switch Q1 to be switched at a high frequency so as to make the average value My of the first current ILp and the input voltage Vr are in phase, thereby achieving the objective of correcting the power factor. In the embodiment, the range of the operating frequency is of 50 Khz to 100 Khz, yet, the range above-mentioned is not limited thereto.

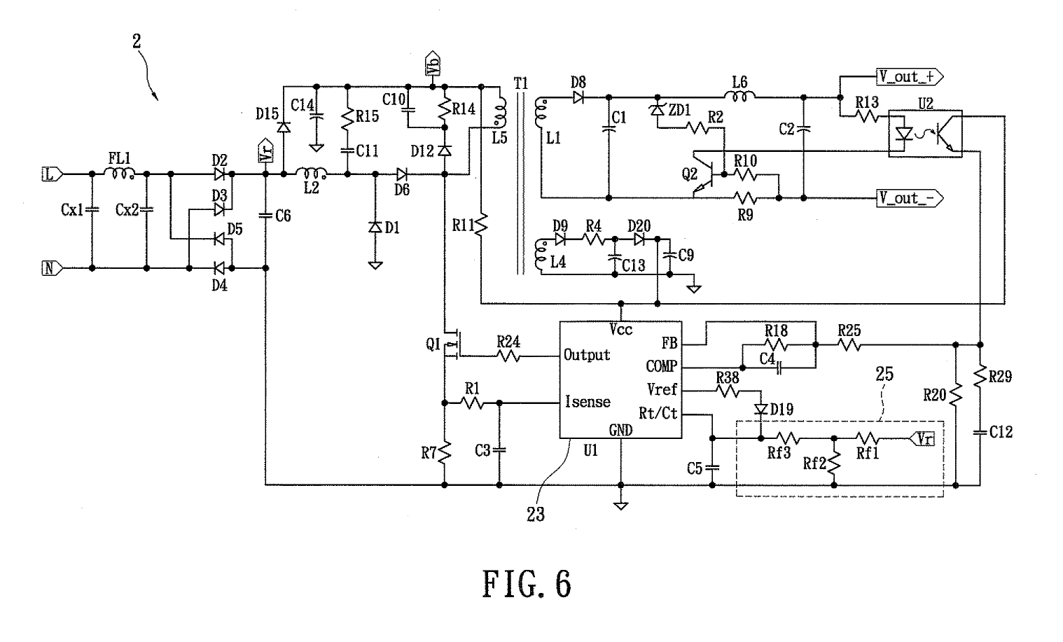

Please refer to FIG. 6 in conjunction with FIG. 2, in which a circuit diagram showing the first embodiment of a first application according to the present invention is demonstrated. The controller 23 of the power conversion apparatus for correcting power factor 2 may be a pulse width modulation controller, e.g., model UC3842/3844. At the same time, the modulation circuit 25 is composed of resistors Rf1, Rf2, Rf3, R38, a diode D19 and a capacitor C5.

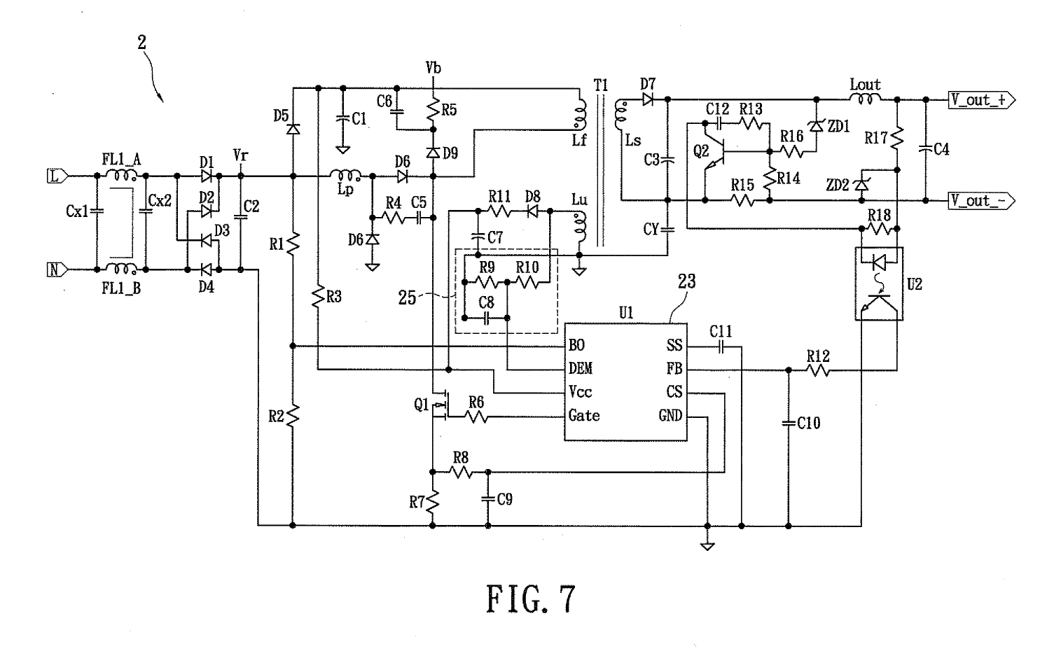

Please refer to FIG. 7 in conjunction with FIG. 2, in which a circuit diagram showing the first embodiment of a second application according to the present invention is demonstrated. The controller 23 of the power conversion apparatus for correcting power factor 2 as shown in FIG. 7 may be a quasi resonant pulse width modulation controller, e.g., model OB2202. Meanwhile, the modulation circuit 25 is composed of resistors R9, R10 and a capacitor C8. When the controller 23 is operated in a quasi resonant (QR) mode, the first current ILp may be maintained at the critical point between the continuous conduction mode (CCM) and the discontinuous conduction mode (DCM),

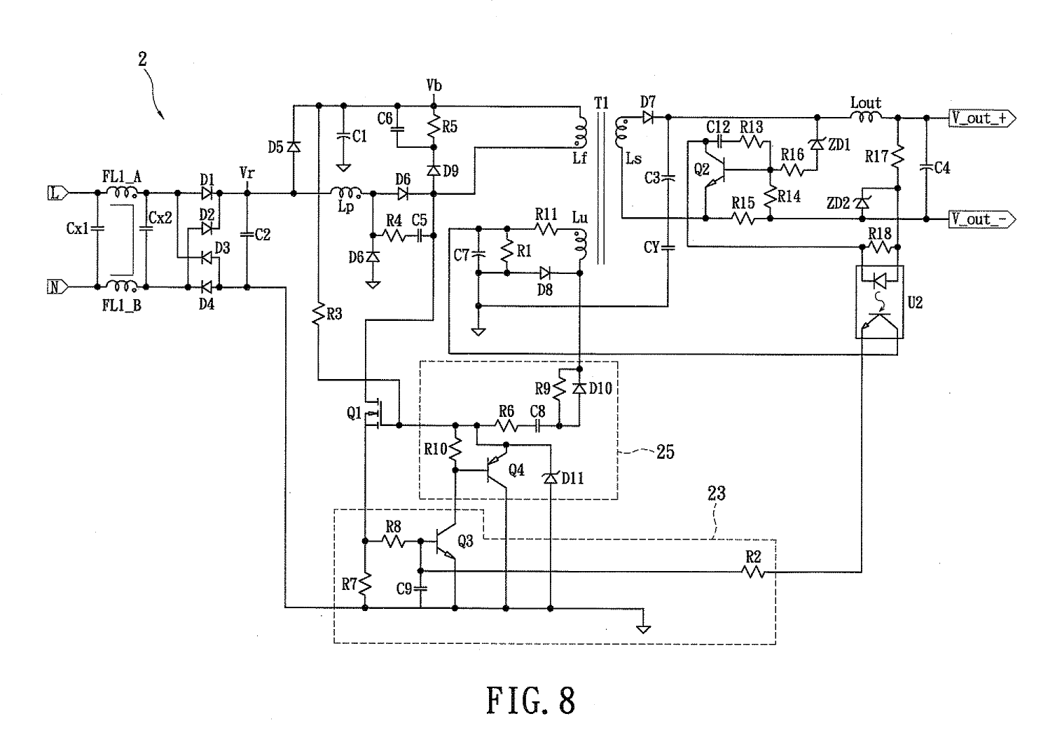

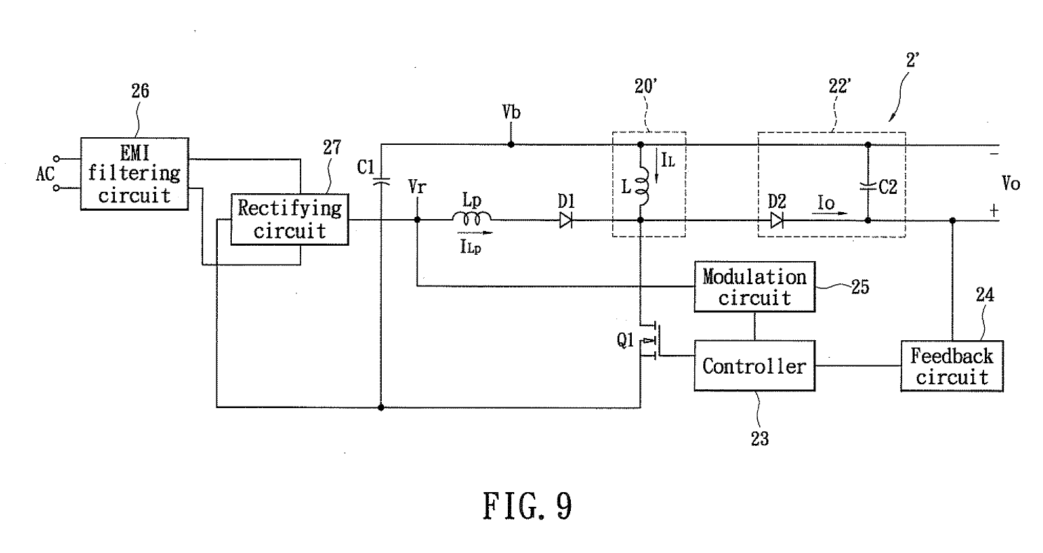

Please refer to FIG. 8 in conjunction with FIG. 2, in which a circuit diagram showing the first embodiment of a third application according to the present invention is demonstrated. The controller 23, the modulation circuit 25, and the switch Q1 of the power conversion apparatus for correcting power factor 2 as shown in FIG. 9 are integrated to be a ringing coke converter. Herein, the controller 23 is composed of resistors R2, R7, R8, a capacitor C9, and a switch Q3. The modulation circuit 25 is composed of resistors R6, R9, R10, a capacitor C8, and diodes D10, D11, and a switch Q4.

Please refer to FIG. 9 in conjunction with FIG. 2, in which a schematic diagram of a second embodiment of the power conversion apparatus for correcting power factor according to the present invention is demonstrated. The components of the first embodiment which are identical to that of the second embodiment according to the present invention are marked by the same labels. The circuit principles and intended effects for the first embodiment and the second embodiment are exactly identical. After comparison the primary difference is: the first embodiment is an isolated power conversion apparatus, and the second embodiment is a non-isolated power conversion apparatus. Herein, the energy storage component 20′ of the second embodiment is an inductor L.

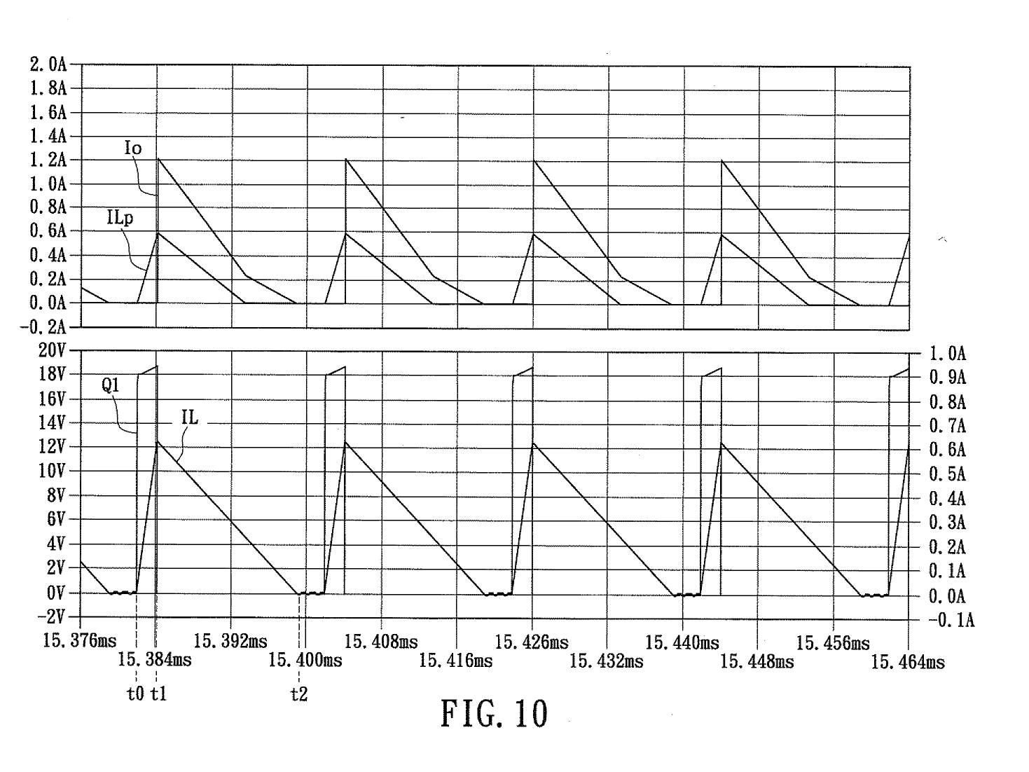

Please refer to FIG. 9 again in conjunction with FIG. 10. In the time line period to-t1, the switch Q1 is controlled to be conducted. When the switch Q1 is in a conduction state, the switch Q1, the inductive component Lp, and the unidirectional conducting component D1 forms a first closed circuit loop. As such, the input voltage Vr is applied to charge the inductive component Lp, and a first current ILp passes thru the switch Q1 in the conduction state, the unidirectional conducting component D1, and thereby storing power to the inductive component Lp. Meanwhile, when the switch Q1 is in the conduction state, the switch Q1, the capacitive component C1, and the energy storage component 20′ form a second closed loop. The bias voltage Vb of the capacitive component C1 is used to charge the energy storage component 20′ by ways of the switch Q1 in the conduction state, and a second current IL passes thru the second closed loop, thereby storing power to the energy storage component 20′.

In the time line period t1-t2, the switch Q1 is controlled to be cut off. At the time, the first current ILp and the second current IL are combined to become an output current Io so as to discharge to the output circuit 22′. When the switch Q1 is in a cutoff state, the first current ILp may not merely pass thru the energy storage component 20′ to discharge to the output circuit 22′ but also charge to the capacitive component C1. The magnitude of the first current ILp decreases or increases with respect to the voltage level of the input voltage Vr. As the magnitude of the first current ILp is smaller than the magnitude of the second current IL, the level of the bias voltage Vb associated with the capacity of the capacitive component C1 may be maintained by means of discharging to the energy storage component 20′. When the magnitude of the first current ILp is larger than the magnitude of the second current IL, the capacitive component C1 is in a charging process, for making the bias voltage Vb of the capacitive component C1 to reach a certain level.

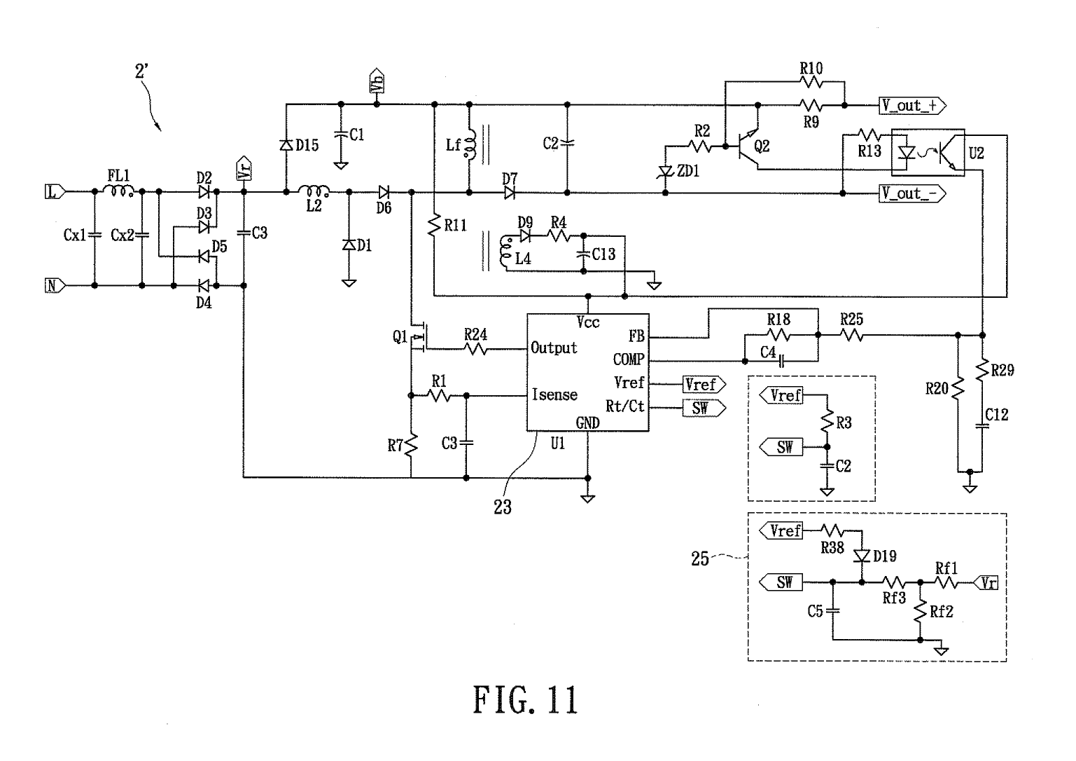

Please refer to FIG. 11 in conjunction with FIG. 9, in which a circuit diagram showing the second embodiment of an application according to the present invention is demonstrated. The controller 23 of the power conversion apparatus for correcting power factor 2′ may be a pulse width modulation controller, e.g. model UC3842/3844. Meanwhile, the modulation circuit 25 is composed of resistors Rf1, Rf2, Rf3, R38, a diode D19, and a capacitor C5.

In other applications of the second embodiment of the power conversion apparatus for correcting power factor 2′, the controller 23 may be a quasi resonant pulse width modulation controller, e.g. model OB2202. Meanwhile, the modulation circuit 25 is composed of resistors R9, R10, and a capacitor C8. The controller 23, the modulation circuit 25, and the switch Q1 may be integrated together to become a ringing choke converter. Wherein, the controller 23 is composed of resistor R2, R7, R8, a capacitor C9, and a switch Q3. The modulation circuit 25 is composed of resistors R6, R9, R10, a capacitor C8, diodes C10, D11, and a switch Q4, as shown in FIG. 8.

In the aspects of the aforementioned embodiments according to the present invention, the power conversion apparatus for correcting power factor has the following efficacy:

Only a single pulse width modulation controller and a single switch transistor are applied, so that the circuitry configuration is simple with low manufacturing cost and high power factor.

Because the operation frequency of the circuitry topology of the flyback power converter is fixed, the input current and input voltage may generate a certain phase difference, but the power factor may maintain above 0.90, so that the circuit design may be a good solution method for applications which has no specific restrictions regarding the power factor.

To modulate the frequency of switch, the pulse width modulation designs according to the present invention may be provided to adjust the power factor easily. The power factor may exceed around 0.98.

Because the DC output stability is good for the enhancement of the modulation associated with the line frequency, an extra large capacity of an output capacitor may not be necessary for modulating the line frequency, thereby reducing space and cost.

Electromagnetic interference prevention is relatively easier, when the peak current value of the inductive component is low.

The aforementioned descriptions represent merely the preferred embodiment of the present invention, without any intention to limit the scope of the present invention thereto. Various equivalent changes, alterations, or modifications based on the claims of present invention are all consequently viewed as being embraced by the scope of the present invention.

What is claimed is:

1. A power conversion apparatus for correcting power factor, adapted to
converting an input voltage to an output voltage, comprising:
an inductive component, for receiving the output voltage;
a unidirectional conducting component, connected with the inductive component in series;
a switch, connected to the inductive component and the unidirectional conducting component in series;
an energy storage component, connected to the switch in series, including:
a capacitive component, connected to the switch and the energy storage component in series, having a bias voltage; and
an output circuit, coupled to the energy storage component, for outputting the output voltage;
wherein, the switch in a conduction state is capable of charging the inductive component by applying the input voltage and charging the energy storage component by applying the bias voltage, and the switch in a cutoff state is capable of discharging the capacitive component and the energy storage component to the output circuit and discharging the inductive component to the capacitive component.

2. The power conversion apparatus for correcting power factor according to claim 1, further including a controller, coupled to the switch, for controlling to cot off or conduct the switch with respect to an operating frequency.

3. The power conversion apparatus for correcting power factor according to claim 2, further including a feedback circuit, coupled to the output circuit and the controller.

4. The power conversion apparatus for correcting power factor according to claim 3, further including a rectifying circuit and an EMI filtering circuit, wherein the rectifying circuit coupled to the EMI filtering circuit and the inductive component, receives an AC voltage from the EMI filtering circuit and outputs the input voltage.

5. The power conversion apparatus for correcting power factor according to claim 4, further including a modulation circuit, coupled to the controller, for modulating the operating frequency with respect to the value of the input voltage.

6. The power conversion apparatus for correcting power factor according to claim 1, wherein the unidirectional conducting component is a diode.

7. The power conversion apparatus for correcting power factor according to claim 1, wherein the inductive component is an inductor.

8. The power conversion apparatus for correcting power factor according to claim 1, wherein the capacitive component is a capacitor.

9. The power conversion apparatus for correcting power factor according to claim 1, wherein the energy storage component is an inductor or a transformer.

10. The power conversion apparatus for correcting power factor according to claim 1, wherein the output circuit includes a diode connected to an output capacitor.

11. The power conversion apparatus for correcting power factor according to claim 2, wherein the controller is a pulse width modulation controller.

12. The power conversion apparatus for correcting power factor according to claim 2, wherein the controller is a quasi resonant pulse width modulation controller.

13. The power conversion apparatus for correcting power factor according to claim 5, wherein the controller, the modulation circuit, and the switch are integrated to be a ringing choke converter.
